(19) United States
(12) Patent Application Publication
(10) Pub. No.: US 2019/0144096 A1
(43) Pub. Date: May 16, 2019

(54) CLAMPING ASSEMBLY

(71) Applicant: David L. McClung, Des Moines, IA (US)

(72) Inventor: David L. McClung, Des Moines, IA (US)

(21) Appl. No.: 15/812,215

(22) Filed: Nov. 14, 2017

(51) Int. Cl. B63H 25/38; F16B 5/12

(52) U.S. Cl. CPC B63H 25/382; F16B 5/128

(57) ABSTRACT

A clamp assembly for connecting a rudder to an aquatic device having a body with a first end, a second end, a top and a bottom. A slot, having more than one section extends into the body from the first end. A clamp having a screw connected to a pivot pin disposed within a clamp head is removably connected to the top of the body for selectively applying a clamping force within the slot.

### BACKGROUND OF THE INVENTION

The present invention is directed to a clamping assembly, and more particularly, a clamping assembly for connecting a rudder to an aquatic device.

Rudders for use with aquatic devices such as paddle boards, surf boards, and the like are well-known in the art. On occasion, rudders break and/or need to be replaced or they need to be removed for transportation and storage. Presently this process is difficult requiring the use of a number of small pieces that need to be aligned that can easily become lost in cold, wet, and sandy conditions. Not only is the process difficult and time consuming, it is also frustrating. Therefore, a need exists in the art for an assembly that addresses these deficiencies.

An objective of the present invention is to provide a clamp assembly that provides a quick and easy connection for a rudder.

Another objective of the present invention is to provide a clamp assembly where parts are difficult to lose.

These and other objectives will be apparent to those skilled in the art based upon the following written description, claims, and drawings.

### SUMMARY OF THE INVENTION

A clamp assembly for connecting a rudder to an aquatic device includes a body having a top, a bottom, a first end, and a second end. Extending inwardly from the first end is a slot which forms a finger along the bottom of the body.

Connected to the top of the body, above the slot, is a clamp having a clamp head and a clamp handle. Disposed within the clamp head is a pivot pin. Transversely connected to the pivot pin, and extending outwardly from the pivot pin and clamp head, is a screw. The screw extends through a socket and an O-ring into a threaded bore. The threaded bore extends through the top of the body to the slot. The socket is formed to moveably receive the clamp head. Through the rotation and pivoting of the clamp, the screw applies a clamping force within the slot.

### BRIEF DESCRIPTION OF THE DRAWINGS

FIG. 1 is a side view of a clamp assembly connecting a rudder to an aquatic device;

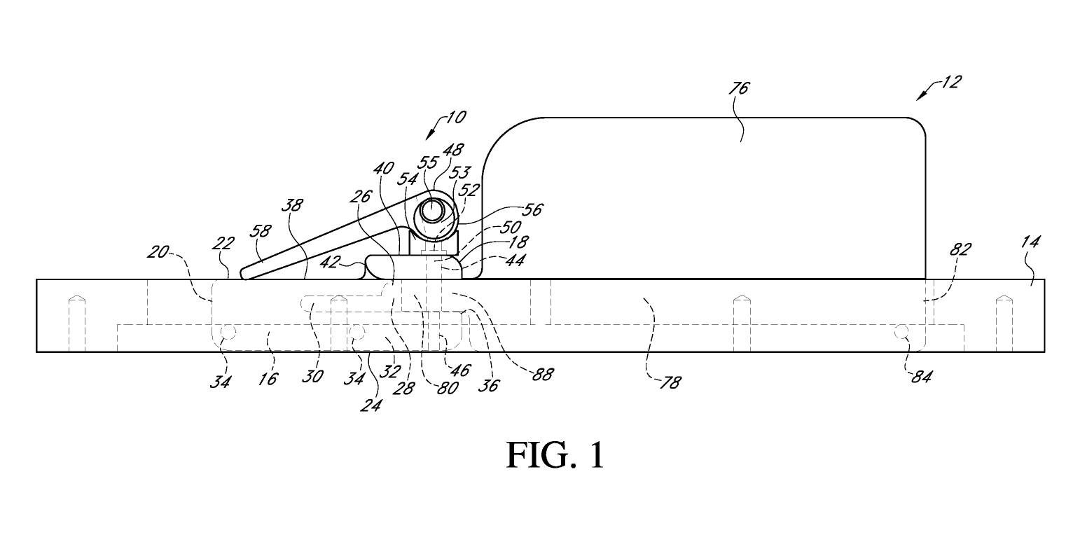

FIG. 2 is a bottom plan view of a clamp assembly connecting a rudder to an aquatic device;

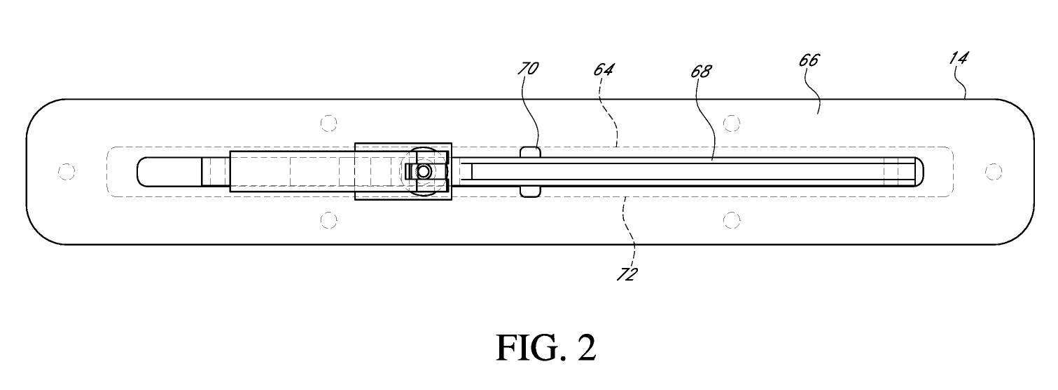

FIG. 3 is a side view of a body of a clamp assembly; and

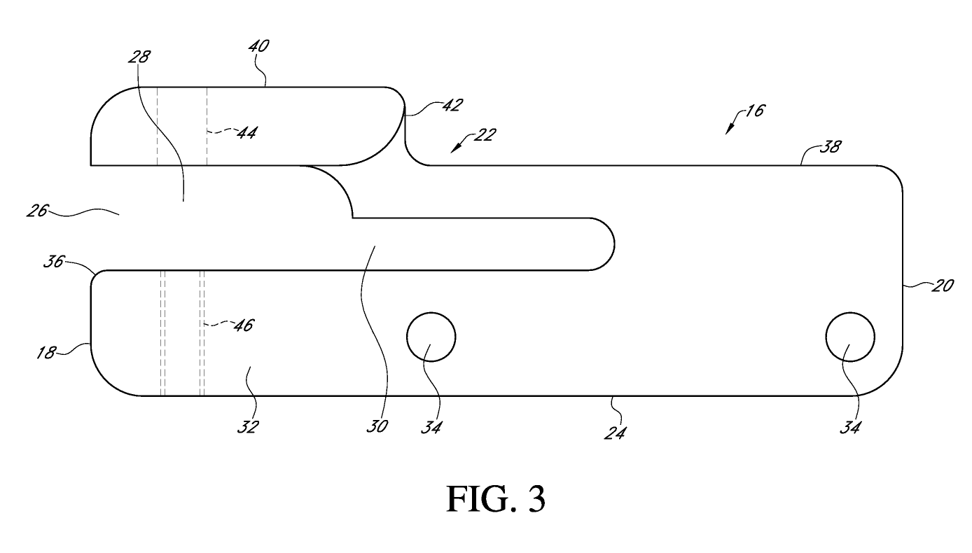

FIG. 4 is a side view of a clamp of a clamp assembly.

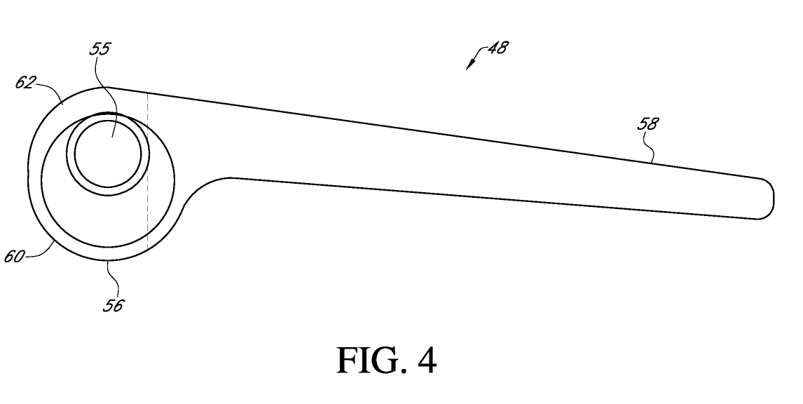

### DETAILED DESCRIPTION OF THE PREFERRED EMBODIMENT

Referring to the Figures, a clamp assembly 10 for securing a rudder 12 to an aquatic device 14 has a body 16 having a first end 18, a second end 20, a top 22 and a bottom 24. A slot 26 that extends from the first end 18 into the body 16 has a first section 28 and a second section 30. The height of the first section 28 of the slot 26 is greater than the height of the second section 30 which creates weakness within the body 16 for clamping.

The slot 26 forms a bottom finger 32 between the slot 26 and the bottom 24 of the body 16. Positioned along the finger 32 is at least one and preferably two pins 34 that extend outwardly and transversely to the body 16. Also, the tip 36 of the finger 32 at the first end 18 is curved or chamfered.

The top 22 has a first section 38 and a second raised section 40 that are separated by a shoulder 42. Preferably, the raised section 40 corresponds with the second section 30 of the slot 26. A threaded bore 44 extends through the raised section 40 from the top 22 to the slot 26. Vertically aligned with bore 44 is a second threaded bore 46 that extends from slot 26 through finger 32.

Attached to the body 16 is a clamp 48. The clamp 48 has a threaded screw 50 that extends through an O-ring 52 and a socket 54. An end 53 of the screw 50 is connected to a pivot pin 55 in a spherical clamp head 56 that is moveably received within the socket 54 and terminates in a clamp handle 58. Preferably, the clamp head 56 has more than one and preferably two angles 60 and 62 that require greater force to rotate the head 56 within the socket 54 making the release of the clamp 48 from the body 16 more secure.

In operation, the body 16 is inserted into a retaining slot 64 on a bottom surface 66 of the aquatic device 14. The aquatic device 14 is of any type such as a surf board, paddle board, kayak, or the like. The retaining slot 64 has an elongated portion 68 that extends along the length of the device 14, a shorter portion 70 transverse to the elongated portion 68, and an internal portion 72 that runs parallel to and outside of the elongated portion 68.

The body 16 is inserted into the retaining slot 64 by aligning and inserting the pins 34 into the transverse portion 70 and once inserted moving the pins 34 along internal portion 72 and the body 16 along the elongated portion 68 to a forward end 74 of the retaining slot 64.

The rudder 12 is then inserted into the retaining slot 64. More specifically, the rudder 12 has a fin 76 that is connected to a support member 78 having a first end 80 and a second end 82. Adjacent the second end 82 is a pin 84 that extends outwardly and transversely to the support member 78. The pin 84 is aligned with and inserted into portion 70 of the retaining slot 64 and then slid to the second end 86 of the retaining slot 64 within the internal portion 72 of slot 64. The first end 80 of the support member 78 has a section 88 that is raised in relation to the rest of the support member 78.

Once the rudder 12 is received within the retaining slot 64, the clamp assembly 10 is slid rearwardly within slot 64 to receive the raised section 88 of the support member 78 within slot 26 of the body 16. The curved or chamfered tip 36 of finger 28 helps to guide the raised section 88 into the slot 26. The clamp head 56 is then rotated clockwise using the clamp handle 58. The rotation of the head 56 causes the screw 50 to move downwardly through threaded bore 44. As the screw 50 moves downward the socket 54 and the head 56 are drawn downwardly against raised section 40 of the body 16 and the screw 50 engages the raised section 88 to apply a clamping force. The handle 58 is then rotated downwardly against the top 22 of the body to apply further clamping force.

For a more secure connection, the raised section 88 of the rudder 12 has a threaded bore 90 that is vertically aligned with bores 44 and 46 and receives screw 50.

Accordingly, a clamp assembly for securing a rudder to an aquatic device has been disclosed that, at the very least, meets all the states objectives.

What is claimed is:

1. A clamp assembly for securing a rudder to an aquatic device, comprising:
a body having a first end, a second end, a top, and a bottom;
a slot in the body that extends from the first end toward the second end; and
a clamp having a screw that extends through a bore in the top of the body to the slot.

2. The assembly of claim 1 wherein the slot forms a bottom finger having a curved tip.

3. The assembly of claim 1 wherein the slot has a first section with a height greater than a second section.

4. The assembly of claim 1 wherein at least one pin extends outwardly and transversely to a bottom finger on the body.

5. The assembly of claim 1 wherein the top of the body has first section and a second section separated by a shoulder.

6. The assembly of claim 1 wherein the screw is connected to a pivot pin disposed within a clamp head of the clamp.

7. The assembly of claim 1 wherein the screw extends through a socket that moveably receives a clamp head.
